(19) United States
(12) Patent Application Publication
(10) Pub. No.: US 2002/0003116 A1
(43) Pub. Date: Jan. 10, 2002

(54) System and method for removal of arsenic from aqueous solutions

(76) Inventor: Josh H. Golden, Santa Cruz, CA (US)

Correspondence Address: FLEHR HOHBACH TEST, ALBRITTON & HERBERT LLP, Suite 3400, Four Embarcadero Center, San Francisco, CA, 94111-4187, US

(21) Appl. No.: 09/894,228

(22) Filed: Jun. 27, 2001

Related U.S. Application Data
(60) Provisional application No. 60/216,759, filed on Jul. 7, 2000.

(51) Int. Cl. C02F 1/52; C02F 1/72

(52) U.S. Cl. 210/759

(57) ABSTRACT

A method and system of removing arsenic from aqueous solutions is provided. Specifically, the aqueous solution includes arsenic, said arsenic being present in the +3 oxidation state. Arsenic can also be present in the +5 oxidation state. The pH of the aqueous solution is first adjusted to a pH in the range of about 3 to 5. Iron salts , such as ferric or an ferrous salts, are introduced into the aqueous solution. Hydrogen peroxide is added to the aqueous solution wherein the arsenic present in the +3 oxidation state is oxidized to the +5 oxidation state. Next, the pH of the aqueous solution is adjusted to a value in the range of about 5 to 8 to form an insoluble ferric hydroxide compound including arsenic in the +5 oxidation state adsorbed onto the compound which is then removed from the aqueous solution.

### FIELD OF THE INVENTION

The present invention relates generally to a system and method of removing arsenic from aqueous solutions, such as drinking water or wastewater. More specifically, the present invention provides an enhanced system and method of removing arsenic from aqueous solutions using pretreatment with an oxidizing agent to assist removal of the arsenic.

### CROSS REFERENCE TO RELATED APPLICATIONS

This application is related to U.S. patent application Ser. Nos.______(Attorney Docket No. A-68834/AJT/MSS ) and______(Attorney Docket No. A-68835/AJT/MSS), both of which are filed simultaneously herewith, and the disclosures of each are hereby incorporated by reference in their entirety.

### BACKGROUND OF THE INVENTION

Arsenic bearing aqueous solutions, such as wastewaters, are obtained from a variety of industries including agriculture, mining, semiconductor, and petroleum. Other sources of arsenic bearing surface and groundwaters include natural erosion processes and water obtained from wells. Recent studies on the carcinogenic properties of arsenic (As) have raised concern about the concentration of As in wastewater and drinking water in the US and worldwide. It has been recognized that many potable water sources are contaminated with unacceptable levels of arsenic and may represent a serious health risk. The current maximum contaminant level (MCL) imposed by the EPA is 50 parts per billion (ppb) or (μg/L); however, based on recent health findings, the EPA may recommend lowering the MCL. Consequently, the MCL is expected to decrease to somewhere in the range of 2 to 20 ppb in the year 2000. The new MCL is expected to create many arsenic removal opportunities in potable and industrial water applications. It is estimated that, in the U.S. alone, more than 12,000 public water utilities would not meet the most stringent MCL requirement, and this does not include the unknown number of private wells that would fail to meet this requirement.

Arsenic occurs in four valence states (also called oxidation states); namely, −3, 0, +3 and +5. Under standard conditions, the +3 and +5 valence states are commonly found as AsO₃³⁺(arsenite) and AsO₄⁵⁺(arsenate). For effective arsenic removal by coagulation processes, arsenic should be in the +5 oxidation state, preferably in the form of arsenate. Arsenite (which is in the +3 oxidation state) is partially removed by techniques such as absorption and coagulation, but the mechanism is less effective because its main form, arsenious acid (H₃AsO₃), is a weak acid (having a pKal of about 9.23), and remains unionized at pH values where removal via absorption occurs most effectively; i.e., in the range of about 5 to 8. In contrast, o-arsenic acid (H₃AsO₄, arsenic in the 5+oxidation state), is a strong acid (having a pKal of about 2.20), and is in an ionized form starting from a pH of approximately 2. The negatively charged form is most effectively absorbed and coagulated.

Various prior art techniques have been employed to remove arsenic from wastewaters. For example, techniques such as co-precipitation, alumina adsorption, and classical ion exchange with anion resins have been used. Such techniques have achieved limited success and are limited to a removal efficiency of only about 95%. Newer techniques have been developed, for example, U.S. Pat. No. 5,368,703 discloses the use of an electrochemical cell which electrochemically generates ferrous ions. A mild oxidizing condition is created by the addition of peroxide which oxidizes the ferrous ions to ferric so that ferric hydroxide is formed. Ferric hydroxide is then used to remove the arsenic. Another prior art technique is described in U.S. Pat. No. 5,908,557 where trivalent arsenic is oxidized to pentavalent arsenic and then removed by a N-alkyl pyridinium containing adsorption medium. Such newer techniques may provide an improvement in the removal efficiency, but such techniques are cumbersome, require specialized equipment and/or specialty chemicals, and are not easily installed or operated, particularly for private well treatment. Accordingly, it is desirable to provide an improved method of removing arsenic from aqueous solutions.

### SUMMARY OF THE INVENTION

Accordingly, it is an object of the present invention to provide an improved system and method for removing arsenic from aqueous solutions. In particular, the inventor has discovered a new system and method which employs, in part, an oxidizing agent, and in particular, an oxidizing reaction using hydrogen peroxide and ferric or ferrous salts in a selected pH range to remove arsenic from aqueous solutions such as drinking water or wastewater.

In general, the present invention provides a method of removing arsenic from an aqueous solution including arsenic in the +3 oxidation state, (the +5 oxidation state may also be present) characterized in that the aqueous solution is treated with a combination of iron salts and peroxide to form an arsenic bearing precipitate or floc. The precipitate is then filtered thereby removing arsenic from the aqueous solution.

In another aspect, the present invention provides a method of removing arsenic from an aqueous solution, comprising the steps of: providing an aqueous solution including arsenic, where the arsenic is present in the +3 oxidation state, and optionally the +5 oxidation state may also be present. The pH of the aqueous solution is first adjusted to a pH in the range of about 3 to 5. Ferric or ferrous salts are then introduced into the aqueous solution. Hydrogen peroxide is added to the aqueous solution to promote oxidation of the arsenic present in the +3 oxidation state to the +5 oxidation state. The pH of the aqueous solution is then adjusted to a pH in the range of about 5 to 8 to form an insoluble ferric hydroxide compound including arsenic in the +5 oxidation state which is adsorbed onto the compound. The arsenic bearing floc or compound is then removed from the aqueous solution.

In another aspect of the present invention, a system is provided, comprising a first reaction tank for receiving the aqueous solution including arsenic and wherein the pH of the aqueous solution is adjusted to a pH in the range of about 3 to 5. Injection means are coupled to the first and/or a second reaction tank, for injecting ferric or ferrous salts, and hydrogen peroxide, into the aqueous solution. A first mixer is coupled to the first reaction tank for mixing the aqueous solution to promote oxidation of the arsenic to the+5 oxidation state. A second reaction tank is provided for receiving the aqueous solution from the first reaction tank wherein the pH of the aqueous solution is adjusted to a pH in the range of about 5 to 8 to form an insoluble ferric hydroxide compound. A filtration system is provided to remove the compound and includes one or more filter vessels having one or more filter membranes arranged in a tubular sock configuration and placed over a slotted tube, and one or more settling tanks.

### BRIEF DESCRIPTION OF THE DRAWINGS

Other objects and advantages of the present invention will become apparent upon reading the detailed description of the invention and the appended claims provided below, and upon reference to the drawings, in which:

FIG. 1 is a block diagram of one example of a treatment system in accordance with the system and method of the present invention.

### DETAILED DESCRIPTION OF THE INVENTION

The inventor has discovered a new system and method which employs in part, an oxidizing agent, and in particular an oxidizing reaction using hydrogen peroxide and iron salts in a selected pH range to remove arsenic from aqueous solutions such as drinking water or wastewater.

In general, the present invention provides a method of removing arsenic from an aqueous solution including arsenic in the +3 oxidation state characterized in that the aqueous solution is treated with a combination of iron salts and peroxide to form an arsenic bearing precipitate or floc. The precipitate is then filtered thereby removing arsenic from the aqueous solution. The combination of hydrogen peroxide and ferric or ferrous salts at a selected pH range is known as the Fenton oxidation reaction (also referred to as Fenton's Reagent). Fenton's reaction has been used to treat organic wastes, such as alcohols, acids, ethers, ketones and the like. The treatment reduces the toxicity of the waste and partially or completely degrades it to carbon dioxide, and the use of Fenton's reaction has been limited to such type of treatment. The inventor has unexpectedly found that Fenton's reaction may be employed as part of a method for removal of arsenic.

More specifically, arsenic is removed from an aqueous solution having arsenic present in the +3 oxidation state. Arsenic in the +5 oxidation state may also be present along with arsenic in the +3 oxidation state. The initial concentration of the arsenic in the aqueous solution will vary greatly and typically will be in the range of about 0.010 to 500 ppm. According to the method of the present invention the pH of the aqueous solution is first adjusted to a pH in the range of about 3 to 5. A pH of about 4 is most preferred. An iron salt, such as one or more ferric or ferrous salts, and peroxide is added into the aqueous solution. The combination of the iron salt and peroxide in the selected pH range oxidizes the arsenic in the +3 oxidation state to the +5 oxidation state. Preferably, the reaction is allowed to occur for a sufficient period of time to allow for the oxidation to take place. The time will vary depending on the initial concentration of arsenic present in the aqueous solution and the flow rate of the aqueous solution, and generally will be in the range of about 3 minutes to 3 hours, with a time of at least ten minutes being most preferred.

Once the oxidation is complete, the next step is to remove the arsenic from the aqueous solution. To remove the arsenic (now in the +5 oxidation state), the pH of the aqueous solution is adjusted to a pH in the range of about 5 to 8. This step produces an arsenic bearing compound (also called a precipitate or floc) by forming an insoluble ferric hydroxide compound which includes arsenic in the +5 oxidation state adsorbed onto the compound. The insoluble arsenic bearing compound is then removed via filtration techniques as further described below, thereby removing arsenic from the aqueous solution. The method of the present invention is capable of removing substantially all of the arsenic in the aqueous solution, and particularly the final concentration of the arsenic after the inventive treatment is generally equal to or less than about 5 ppb, and preferably equal to or less than about 2 ppb.

The inventor has discovered that the combination of peroxide and iron salts in the first recited pH range provides a suitable oxidizing environment for oxidizing the arsenic. Without wishing to be constrained by any particular theory, it is believed that in this pH range, the ferric and/or ferrous ions catalyze the decomposition of the hydrogen peroxide via a free radical mechanism thus producing a potent oxidizing medium.

Iron salts suitable for use with the present invention are ferric salts, ferrous salts, or a combination thereof, such as chlorides, sulfates or nitrates. Preferable ferric salts include those selected from the group of: ferric nitrate, ferric chloride, ferric acetate, ferric ammonium sulfate, ferric ammonium chloride, ferric hydroxide and ferric oxide. Preferable ferrous salts include those selected from the group of: ferrous chloride, ferrous acetate, ferrous ammonium sulfate, ferrous ammonium chloride, ferrous hydroxide and ferrous oxide.

In an alternative embodiment of the present invention, the aqueous solution may be treated prior to removing the arsenic bearing compound, with organic or inorganic flocculating agents, or a combination thereof, to enhance formation of the arsenic bearing compound. Suitable flocculating agents include polymeric flocculants, either anionic or cationic, of the appropriate molecular weight, such as in the range of about 5,000 to 500,000 g/mole. In a further alternative embodiment of the present invention, a reducing agent may be added such as sodium bisulfite or other reducing agents prior to or after removing the arsenic bearing compound, to destroy any residual peroxide remaining in the aqueous solution after the oxidation step.

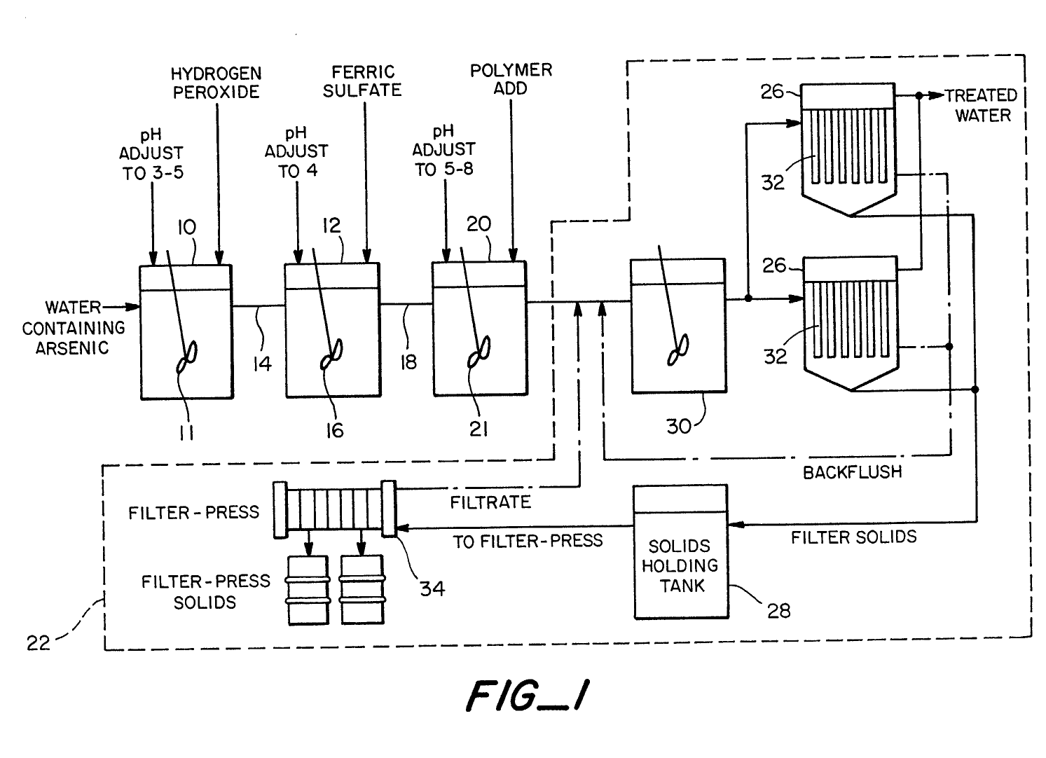

The method of the present invention may be carried out with any suitable water treatment system and is not limited by any particular apparatus or system, however, the method is preferably carried out in the system of the present invention as described below. One example of the system of the present invention is illustrated in FIG. 1. FIG. 1 shows an arsenic removal system, generally comprised of one or more reaction tanks, associated mixers and a filtration system. Preferably, the filtration system is of the type described in U.S. Pat. Nos. 5,871,648 and 5,904,853, the entire disclosures of which are hereby incorporated by reference. Specifically, the arsenic containing aqueous solution is fed to a first reaction tank 10. The pH of the solution in the first reaction tank is adjusted to pH in the range of about 3 to 5, and peroxide, such as hydrogen peroxide, is added to the tank 10. Any grade or concentration of hydrogen peroxide may be used. A mixer 11 is provided to ensure mixing of the solution in the tank 10.

The solution is then fed to a second reaction tank 12 via delivery line 14. The iron salts, such as ferric sulfate or ferric chloride are added to the second reaction tank and the solution is agitated with mixer 16 to ensure mixing of the components. Alternatively, the iron salts may be added to the solution via an inline mixer (not shown) placed in the delivery line 14. The iron salts may be in solid or solution form. Preferably, the concentration ratio of peroxide to iron salts in the aqueous solution is in the general range of about 1 to 5.

In the second reaction tank 12 the pH is adjusted to make sure the aqueous solution is in the recited pH range of about 3 to 5, and preferably is adjusted to a pH of about 4 in the second reaction tank 12. The solution is mixed with mixer 16 for a period of time to allow substantially complete oxidation of the As 3+to As 5+. The time will vary depending on the size of the reaction tank 12 and the initial arsenic concentration of the aqueous solution, and will preferably be at least about 10 minutes.

Once oxidation is complete, the solution is fed to a feed tank 20 via delivery line 18 and the pH of the aqueous solution is adjusted upwards to a pH in the range of about 5 to 8. The solution is mixed with mixer 21. The size of the feed tank 20 should be such that the residence time of the aqueous solution is three minutes or greater, with about ten minutes being most preferred. At this pH, an insoluble ferric hydroxide compound is formed. The compound is in the form of particles, also referred to as a precipitate or floc. The +5 arsenic is absorbed onto the insoluble ferric hydroxide compound.

In one embodiment, an inline mixer (not shown) may be placed in delivery line 18 in order to add a reducing agent, such as sodium bisulfite, to remove any remaining peroxide in the solution. In another exemplary embodiment, a polymer or other coagulant agent may be optionally added to the feed tank 20 to aid formation of the insoluble compound.

Once formed, the ferric hydroxide particles containing arsenic are fed by pump or gravity into a filtration system 22. Any suitable filtration system may be used. FIG. 1 illustrates the preferred embodiment of a suitable filtration system. The filtration system 22 in FIG. 1 is comprised generally of a membrane filtration system such as a microfiltration system described in greater detail in US Pat. Nos. 5,871,648 and 5,904,853, the entire disclosures of which is hereby incorporated by reference. In this example, the filtration system generally includes one or more filter or microfiltration tanks 26 and a settling or sludge holding tank 28. A backflush tank 30 may be used, and is preferably placed prior to the filter tanks 26. The filter tank 26 is operated in two modes; namely, a filter tank operating mode and the filter tank backflush mode. The filter tank 26 generally includes a filtration membrane in a tubular “sock” configuration. The membrane sock is placed over a slotted tube to prevent the sock from collapsing during use. The membrane material is commercially available from a variety of sources, and preferably has a pore size in the range of 0.5 to 10 microns, with a pore size of 1 micron being most preferred.

During the operation mode, the arsenic bearing ferric hydroxide particles are dewatered and filtered from the aqueous solution. The aqueous solution is pumped from the filter vessel through the membrane, and as the aqueous solution passes through the membrane, the particles do not pass through, and instead build up on the outside of the membrane surface. The “clean” aqueous solution overflows out of the top of the filter tank for discharge or recycling. The clean aqueous solution is substantially free of arsenic, and contains an arsenic concentration of equal to or less than 10 ppb, and more preferably equal to or less than 2 ppb.

More specifically, the filter tank is preferably equipped with an array of microfiltration membranes 32. Preferably, the microfiltration membranes are comprised of a tubular “sock” configuration to maximize surface area. The membrane sock is placed over a slotted support tube to prevent the sock from collapsing during use. In order to achieve high flow rates and flux values, a number of membranes or membrane modules, each containing a number of individual filter socks, may be used. The microfiltration membranes preferably have a pore size in the range from 0.5 μm to 10 μm microns, and preferably from 0.5 μm to 1.0 μm. It has been found that the treated wastewater flow rate through 0.5 to 1 μm microfiltration membranes can be in the range from 200 GFD to 1500 GFD.

The microfiltration membranes are preferably provided in cassette or module or in a preformed plate containing the membrane array. In either case, the membranes are conveniently installed or removed from the top by unscrewing a collar fitting. Alternatively, the entire cassette or plate may be removed for servicing. The microfiltration membranes provide a positive particle separation in a high recovery dead head filtration array. The dead head filtration operates effectively at low pressures (3 psi to 25 psi, preferably 5 psi to 10 psi) and high flow rates, allowing a one pass treatment with up to 99.9% discharge of the supplied water. Solids which accumulate on the membrane surface during filtration are periodically backflushed away (and gravity settled) from the membrane surface to ensure a continuously clean filtration media. Currently, the preferred filter socks useful with the present invention contain a Teflon® coating on a poly(propylene) or poly(ethylene) felt backing material. Such socks are available from W.L. Gore. Another presently preferred filter sock manufactured by National Filter Media, Salt Lake City, Utah, consists of a polypropylene woven membrane bonded to a poly(propylene) or poly(ethylene) felt backing. Because the membranes are simple and inexpensive, some operations deem it more cost-effective to replace the membrane socks instead of cleaning contaminants from the membrane. However, it should be noted that the membranes are very resistant to chemical attack from acids, alkalis, reducing agents, and some oxidizing agents. Descaling of the membranes is achieved by acid washing, while removal of biofouling may be accomplished by treatment with hydrogen peroxide, dilute bleach, or other suitable agents.

To remove the arsenic bearing particles from the membrane surface and the filter vessel, the filter vessel is placed in backflush mode. The membranes are periodically backflushed to keep the flow rate high through the system. Solids are preferably removed from the membrane surface by periodically backflushing the microfiltration membranes and draining the filtration vessel within which the membranes are located. Preferably, the backflush is initiated when the pressure at the membrane builds to approximately 6 psi. The periodic, short duration back flush removes any buildup of contaminants from the walls of the microfiltration membrane socks. Backflush is achieved but is not restricted to a gravity scheme, i.e., one in which a valve is opened and the 1 to 2 feet of water headspace above the filter array provides the force that sloughs off the filter cake. The dislodged solid material within the filtration vessel is then transferred into a sludge holding tank for further processing of the solids. The microfiltration as described is fully automated and can run 24 hours, seven days a week, with minimal input from the operator. The system may be completely automated using process logic control (PLC) which can communicate with supervisory and control data acquisition systems (SCADA). Simple and rugged hardware continuously monitors the characteristics of the influent and effluents and adjusts the chemical feed as needed. Examples of parameters automatically monitored include pH, turbidity, oxidation reduction potential, particle zeta potential, and metal contaminant concentration. Process development and fine-tuning is achieved by continuous monitoring of the process parameters followed by control adjustment. In the backflush mode, the flow of the system is reversed where water from the headspace above the filter array flows in reverse. This is achieved by opening a valve on the filter tank. The particles or sludge settles on the bottom of the filter vessel, and then are pumped or gravity feed to the sludge holding tank 28 and removed. A filter press 32 may be used to provide further dewatering of the particles, if desired. It is important to note that while one type of treatment system has been described, the method of the present invention may be carried out in a wide number of different types of treatment systems, such as for example gravity settling and cross-flow filtration systems.

### Experimental

The following prospective example is provided for illustration purposes only and is not intended to limit the invention in any way.

Areas with geothermal activity and hot springs contribute arsenic bearing water that is collected by wells and reservoirs. These sources may represent a significant input of toxic dissolved arsenic for potable water. The total concentration of the arsenic in these waters can be 100 ppb or greater. In addition, a large fraction of the total arsenic in these waters consists of arsenic in the +3 oxidation state, which as described above is more difficult to remove by coagulation and filtration than arsenic that occurs in the +5 oxidation state. Finally, although the average arsenic concentration in the aqueduct water is 20 ppm, by the year 2001, the EPA will likely impose more stringent arsenic standards. The new maximum contaminant level is expected to range from 2 to 20 ppb.

In one prospective example, to carry out the method of the present invention for a town or community, such as a factious town of Kai, a 15,000 gallons per minute (gpm) EnChem™ microfiltration system is preferably installed at a geothermal source of arsenic bearing water, such as Sonny Creek, that serves as a primary source of potable water for the town. Sonny Creek contains water bearing arsenic at a concentration of about 300 ppb, 75% of which is in the +3 oxidation state (As (III)). The EnChem™ system would preferably be installed because of its high flow rate, high flux capacity of 1,500 GFD (gallons/ft²/day), and small footprint (50′×100′). Coupled to the high flow microfiltration system is one or more reaction tanks with pH adjustment means, similar to that illustrated in FIG. 1 and described above for carrying out oxidation of the arsenic (III) to arsenic (V), and for precipitating the arsenic (V) bearing compound for removal by the EnChem™ microfiltration system. The complete system is designed for high flow arsenic removal using a chemical process that uses a common chemical to both oxidize and remove the arsenic.

Specifically, the process would be carried out as follows: arsenic bearing wastewater, gravity fed from Sonny Creek at 10,000 gpm, is treated with technical grade hydrogen peroxide solution, by inline injection. Hydrogen peroxide is added until a concentration of at least about 50 ppm is reached. The grade or concentration of the hydrogen peroxide used is not important, only the final concentration in the water. The hydrogen peroxide containing water is gravity fed into a 1,000 gallon reaction tank in which the pH of the water is adjusted to the range of about 3 to 5 with a pH of about 4 being preferred. The size of the reaction tank should be such that the residence time of the water is 3 minutes or greater, with 10 minutes being preferred. The reaction mixture should be well stirred, at a rate of at least 50 RPM. A ferric sulfate, solution having a pH of about 2 is added concurrently so that the ferric ion concentration in the water is at least 10 ppm. As described above, the ferric ion serves to catalyze the decomposition of the hydrogen peroxide into free radicals, which rapidly oxidize the arsenic (III) species to arsenic (V). The ratio of hydrogen peroxide to iron (in wt/wt) in the water can range from about 1 part iron to 2 or more parts of hydrogen peroxide. The preferred ratio of hydrogen peroxide to iron is in the range of about 1 to 5.

The mixture from the first reaction tank is then fed into a second 1,000 gallon reaction tank where the pH is adjusted to the range of about 5 to 8, with 6 being preferred. The size of the second reaction tank should be such that the residence time of the water is 3 minutes or greater, with 10 minutes being preferred. In the pH range of 5 to 8, ferric hydroxide is formed, which absorbs the arsenic (V) created in the previous step. Optionally, an additional polymer coagulant may be injected inline after the first reaction tank, or alternatively into the second reaction tank, to create larger particles for the following filtration step. The concentration of the polymer coagulant in the water is in the range of about 5 to 100 ppm, with 5 ppm being preferred. The polymer coagulant used can be cationic or anionic in nature, with the preferred embodiment being cationic with a molecular weight that ranges from 5,000 to 500,000. Polymer coagulant's meeting this criteria include, but are not limited to EPI-DMA, DADMAC and copolymers of poly(acrylamide) and DADMAC.

After the final pH is adjusted in the second reaction tank, with or without polymer addition, the ferric hydroxide particles containing the arsenic are fed by pump or by gravity into the EnChem™ system containing the filter arrays. The filtration system can operate automatically for 24 hrs, 7 days a week, with minimal input from the operator. Composite water samples would preferably be collected every twenty-four hours and analyzed by graphite furnace atomic absorption spectroscopy (GFAA) with or without hydride generation. The arsenic level in the samples, collected over a 6-months period, are preferably 2 ppb or less.

The present invention provides many advantages. For example, the present invention uses inexpensive ferric or ferrous salts to catalyze the decomposition of hydrogen peroxide ( a commodity chemical) which then oxidizes arsenic. The ferric ions used in the Fenton reaction are then used to coagulate and remove the oxidized arsenic after the pH is adjusted upwards. Other chemicals that have been used in the prior art to oxidize arsenic include: oxygen in the presence of activated carbon, chlorine, bleach, permanganate, and UV light. All of these methods suffer many disadvantages in comparison to the present invention. Such disadvantages of the prior art include, but not limited to, increased expense, care needed in handling, the formation of toxic byproducts, and the inability to produce a coagulation agent after oxidation.

As taught by the foregoing description and examples, an improved method for removing arsenic from aqueous solutions has been provided by the present invention. The foregoing description of specific embodiments and examples of the invention have been presented for the purpose of illustration and description, and although the invention has been illustrated by certain of the preceding examples, it is not to be construed as being limited thereby. They are not intended to be exhaustive or to limit the invention to the precise forms disclosed, and obviously many modifications, embodiments, and variations are possible in light of the above teaching. It is intended that the scope of the invention encompass the generic area as herein disclosed, and by the claims appended hereto and their equivalents.

I claim:

1. A method of removing arsenic from an aqueous solution including arsenic in the +3 oxidation state, characterized in that the aqueous solution is treated with a combination of iron salts and hydrogen peroxide to oxidize the arsenic and to form an arsenic bearing compound which is removed, thereby removing the arsenic from the aqueous solution.

2. The method of claim 1 wherein the pH of the aqueous solution is maintained in the range of about 3 to 5 during said oxidizing of the arsenic.

3. The method of claim 1 wherein the pH of the aqueous solution is maintained in the range of about 5 to 8 during said forming of the arsenic bearing compound.

4. The method of claim 1 wherein the iron salts are comprised of ferric salts, ferrous salts, or combinations thereof.

5. The method of claim 4 wherein said ferric salts are selected from the group of: ferric nitrate, ferric chloride, ferric acetate, ferric ammonium sulfate, ferric ammonium chloride, ferric hydroxide and ferric oxide.

6. The method of claim 4 wherein said ferrous salts are selected from the group of: ferrous chloride, ferrous acetate, ferrous ammonium sulfate, ferrous ammonium chloride, ferrous hydroxide and ferrous oxide.

7. The method of claim 1 further comprising the step of: treating said aqueous solution, prior to removing the compound, with organic or inorganic flocculating agents , or a combination thereof, to enhance formation of the arsenic bearing compound.

8. The method of claim 1 wherein said treatment is carried out for a time of at least about 10 minutes.

9. The method of claim 1 further comprising the step of: treating the aqueous solution with a reducing agent, prior to removing the compound, to destroy any residual peroxide.

10. The method of claim 1 wherein the arsenic bearing compound is removed by any one of, or any combination of, the following techniques: filtering, gravity or settling.

11. The method of claim 1 wherein the concentration ratio of hydrogen peroxide to iron in weight percent is in the range of about 1 to 5.

12. The method of claim 4 wherein the concentration of ferric ions in the aqueous solution is at least 10 ppm.

13. A method of removing arsenic from an aqueous solution, comprising the steps of:
providing an aqueous solution including arsenic, said arsenic being present in at least the +3 oxidation state;
first adjusting the pH of the aqueous solution to a pH in the range of about 3 to 5;
introducing ferric or an ferrous salt into the aqueous solution;
adding hydrogen peroxide into the aqueous solution wherein the arsenic present in the +3 oxidation state is oxidized to the +5 oxidation state;
second adjusting the pH of the aqueous solution to a pH in the range of about 5 to 8 to form an insoluble ferric hydroxide compound including arsenic in the +5 oxidation state adsorbed onto the compound; and
removing said compound including the arsenic from the aqueous solution.

14. The method of claim 13 wherein said ferric salts are selected from the group of: ferric nitrate, ferric chloride, ferric acetate, ferric lactate, ferric ammonium sulfate, ferric ammonium chloride, ferric hydroxide and ferric oxide.

15. The method of claim 13 wherein said ferrous salts are selected from the group of: ferrous chloride, ferrous acetate, ferrous lactate, ferrous ammonium sulfate, ferrous ammonium chloride, ferrous hydroxide and ferrous oxide.

16. The method of claim 13 further comprising the step of: treating said aqueous solution, prior to filtering, with organic or inorganic flocculating agents , or a combination thereof, to enhance formation of the arsenic bearing precipitate.

17. The method of claim 13 wherein said treatment is carried out for a time of at least about 10 minutes.

18. The method of claim 13 further comprising the step of: prior to or after filtration, second treating the aqueous solution with a reducing agent to destroy any residual peroxide.

19. The method of claim 13 wherein the concentration ratio of hydrogen peroxide to ferric or ferrous salts in weight percent is in the range of about 1 to 5.

20. The method of claim 13 wherein the concentration of ferric ions in the aqueous solution is at least 10 ppm.

21. A system for removing arsenic from an aqueous solution including arsenic in the +3 oxidation state, comprising:
a first reaction tank for receiving the aqueous solution and wherein the pH of the aqueous solution is adjusted to a pH in the range of about 3 to 5;
a second reaction tank for receiving the aqueous solution from the first reaction tank;
at least one inlet for injecting hydrogen peroxide and ferric or ferrous salts into any one of the first or second reaction tank to promote oxidation of the arsenic to a +5 oxidation state, and wherein the pH of the aqueous solution in the second reaction tank is adjusted to a pH in the range of about 5 to 8 to form an insoluble arsenic bearing compound; and
a filtration system to remove the insoluble arsenic bearing compound, said filtration system including one or more filter membranes arranged in a tubular sock configuration and placed over a slotted tube, and one or more settling tanks.

22. The system of claim 21 having two inlets for independently injecting the hydrogen peroxide and ferric or ferrous salts.

23. The system of claim 21 wherein said filtration system is capable of filtering the aqueous solution at a flow rate of up to 800 gallon/ft²/day.

24. The system of claim 21 wherein said filtration system is operated at a maximum pressure of about 10 psi.
